(19) United States
(12) Patent Application Publication
(10) Pub. No.: US 2017/0341469 A1
(43) Pub. Date: Nov. 30, 2017

(54) NON-PNEUMATIC TIRE

(71) Applicant: IL HO CHOI, Jeollabuk-do (KR)

(72) Inventor: IL HO CHOI, Jeollabuk-do (KR)

(21) Appl. No.: 15/168,239

(22) Filed: May 30, 2016

(51) Int. Cl. B60C 7/14; B60C 11/03

(52) U.S. Cl. CPC B60C 7/14; B60C 11/03; B60C 2007/146

(57) ABSTRACT

A non-pneumatic tire includes a body and a tire tread portion on the body, wherein the body comprises an outer cylindrical member, an inner cylindrical member coupled to a wheel shaft, and a plurality of spokes disposed between and coupled to the outer cylindrical member and the inner cylindrical member, wherein the spokes are embodied as a connection of an annular series of a plurality of ellipse shape tubes or a connection of an annular series of a plurality of arch shape tubes in an intermediate cylindrical space defined between the inner and outer cylindrical members.

### BACKGROUND

### Field of the Present Disclosure

The present disclosure relates to a non-pneumatic tire and, more particularly, to a non-pneumatic tire with a smaller size, a light weight, and good load-endurance.

### Discussion of the Related Art

The pneumatic tire has capabilities in load carrying, road shock absorption, and force transmission (accelerating, stopping, and steering) that make it the preferred choice for use on many vehicles, most notably, bicycles, motorcycles, automobiles, and trucks. These capabilities have also been highly advantageous in the development of the automobile and other motor vehicles. Pneumatic tire capabilities in shock absorption are also useful in other applications, for example, in carts carrying sensitive medical or electronic equipment.

Conventional non-pneumatic alternatives, for example, solid tires, spring tires, and cushion tires lack the performance advantages of pneumatic tires. In particular, solid and cushion tires rely on compression of the ground-contacting portion for load support. These types of tires can be heavy and stiff and lack the shock absorbing capability of pneumatic tires. When made more resilient, conventional non-pneumatic tires lack the load support or endurance of pneumatic tires. Accordingly, except in limited situations, known non-pneumatic tires have not found wide use as substitutes for pneumatic tires.

A non-pneumatic tire/wheel having performance characteristics similar to those of pneumatic tires would overcome the various deficiencies in the art and would be a welcome improvement.

### SUMMARY

Form considerations of the above situations, the present disclosure provides a non-pneumatic tire with good load-endurance, where the non-pneumatic tire may not deform beyond a reference degree which otherwise may cause a vehicle risk.

Further, the present disclosure provides a non-pneumatic tire with a smaller size, and a light weight, which may allow the vehicle to carry the non-pneumatic tire as a secondary tire in a more economical manner.

In an aspect of the present disclosure, there is provided a non-pneumatic tire comprising: a body and a tire tread portion on the body, wherein the body comprises an outer cylindrical member, an inner cylindrical member coupled to a wheel shaft, and a plurality of spokes disposed between and coupled to the outer cylindrical member and the inner cylindrical member, wherein the spokes are embodied as a connection of an annular series of a plurality of ellipse shape tubes or a connection of an annular series of a plurality of arch shape tubes in an intermediate cylindrical space defined between the inner and outer cylindrical members, wherein the ellipse shape or arch shape of the tubes is a shape of a cross section thereof perpendicular to a rotation axis of the tire.

In one embodiment, each of the ellipse or arch shape tubes includes at least one ellipse or arch shape sub-tube.

In one embodiment, the number of the at least one ellipse or arch shape sub-tube in each of the ellipse or arch shape tube is in a range of 1 to 10.

In one embodiment, an outer ellipse or arch shape sub-tube encompasses an inner ellipse or arch shape sub-tube.

In one embodiment, an outer ellipse or arch shape sub-tube encompasses an intermediate ellipse or arch shape sub-tube which encompasses an inner ellipse or arch shape sub-tube.

In one embodiment, a most-outer ellipse or arch shape sub-tube encompasses a next most-outer ellipse or arch shape sub-tube, and/or a most-inner ellipse or arch shape sub-tube is encompassed with a next most-inner ellipse or arch shape sub-tube.

In one embodiment, a vertex portion of the arch shape tube faces a ground.

In one embodiment, the tire tread portion has a first end having a coupling groove formed therein and a second end having a coupling protrusion formed thereon, wherein the coupling protrusion is engaged with the coupling groove.

In one embodiment, the tire tread portion has two free ends having mutual engaging steps formed thereon respectively, and the mutual engaging steps are coupled to each other using an adhesive.

In one embodiment, the tire tread portion has, at one end, an outer face portion having micro-protrusions, grooves and protrusions formed therein or thereon, and, at the other end, an inner face portion having corresponding micro-protrusions, grooves and protrusions, wherein the grooves and protrusions of the outer face are engaged with the corresponding protrusions and grooves of the inner face.

In one embodiment, the tire tread portion has an outer face portion having micro-protrusions, grooves and protrusions formed therein or thereon, and the outer cylindrical member has an inner face portion having corresponding micro-protrusions, grooves and protrusions which are engaged with the grooves and protrusions of the tread portion.

In one embodiment, the body may be made of at least one selected from the group consisting of polyurethane, diene based natural and synthetic rubbers, polyester fibers, Kevlar fibers, waste silk fibers, polyurethane thermoplastic resin, and carbon fibers.

### BRIEF DESCRIPTIONS OF THE DRAWINGS

The accompanying drawings included to provide a further understanding of the present disclosure illustrate embodiments of the present disclosure.

FIG. 1 shows a cross sectional view of a non-pneumatic tire including a connection of an annular series of a plurality of ellipse shape tubes in an intermediate cylindrical space in accordance with one embodiment of the present disclosure.

FIG. 2 shows a cross sectional view of a non-pneumatic tire including a connection of an annular series of a plurality of arch shape tubes in an intermediate cylindrical space in accordance with one embodiment of the present disclosure.

FIG. 3 shows a configuration of an outer face of a tread portion of a non-pneumatic tire in accordance with one embodiment of the present disclosure.

FIG. 4 shows a configuration of an inner face of a tread portion of a non-pneumatic tire in accordance with one embodiment of the present disclosure.

FIG. 5 shows a cross-section of a tread portion of a non-pneumatic tire in accordance with one embodiment of the present disclosure.

FIG. 6 shows a cross sectional view of a non-pneumatic tire including a connection of an annular series of a plurality of ellipse shape tubes in an intermediate cylindrical space in accordance with one embodiment of the present disclosure.

FIG. 7 shows a cross sectional view of various configurations of an ellipse shape tube in accordance with one embodiment of the present disclosure.

FIG. 8 shows a cross sectional view of one example of an ellipse shape tube in accordance with one embodiment of the present disclosure.

FIG. 9 shows a cross sectional view of various configurations of an arch shape tube in accordance with one embodiment of the present disclosure.

### DETAILED DESCRIPTIONS

Examples of various embodiments are illustrated in the accompanying drawings and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

Example embodiments will be described in more detail with reference to the accompanying drawings. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Spatially relative terms, such as “beneath,” “below,” “lower,” “under,” “above,” “upper,” and the like, may be used herein for ease of explanation to describe one element or feature's relationship to another element s or feature s as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented for example, rotated 90 degrees or at other orientations, and the spatially relative descriptors used herein should be interpreted accordingly.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present disclosure refers to “one or more embodiments of the present disclosure.”

Hereinafter, embodiments of the present disclosure will be described in details with reference to attached drawings.

In accordance with the present disclosure, spokes disposed between inner and outer cylindrical members 10 and 20 are embodied as a connection of an annular series of a plurality of ellipse shape tubes 42 or a connection of an annular series of a plurality of arch shape tubes 42-1 in an intermediate cylindrical space 40 defined between the inner and outer cylindrical members 10 and 20, wherein the ellipse shape or ellipse shape of the tubes is a shape of a cross section thereof perpendicular to a rotation axis of the tire. In this way, the non-pneumatic tire with good load-endurance may be achieved where the non-pneumatic tire may not deform beyond a reference degree which otherwise may cause a vehicle risk. Further, a non-pneumatic tire with a smaller size, and a light weight may be achieved which may allow the vehicle to carry the non-pneumatic tire as a secondary tire in a more economical manner.

In one aspect of the present disclosure, a non-pneumatic tire 100 may include an outer cylindrical member 10 having a tire tread portion 30 formed thereon, an inner cylindrical member 20 coupled to a wheel shaft, and a plurality of spokes disposed between and coupled to the outer cylindrical member 10 and the inner cylindrical member 20, wherein each of the inner and outer cylindrical members has a constant width along a vehicle shaft, and only the spokes disposed between the inner and outer cylindrical members radially and arranged in a given distance withstand a grounding load of the tire, wherein the spokes disposed between the inner and outer cylindrical members 10 and 20 are embodied as a connection of an annular series of a plurality of ellipse shape tubes 42 or a connection of an annular series of a plurality of arch shape tubes 42-1 in an intermediate cylindrical space 40 defined between the inner and outer cylindrical members 10 and 20, wherein the ellipse shape or arch shape of the tubes is a shape of a cross section thereof perpendicular to a rotation axis of the tire.

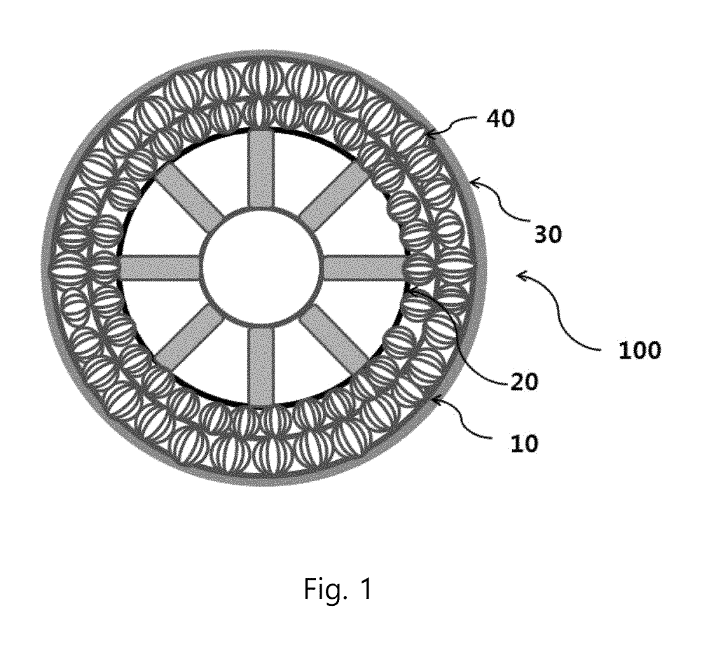

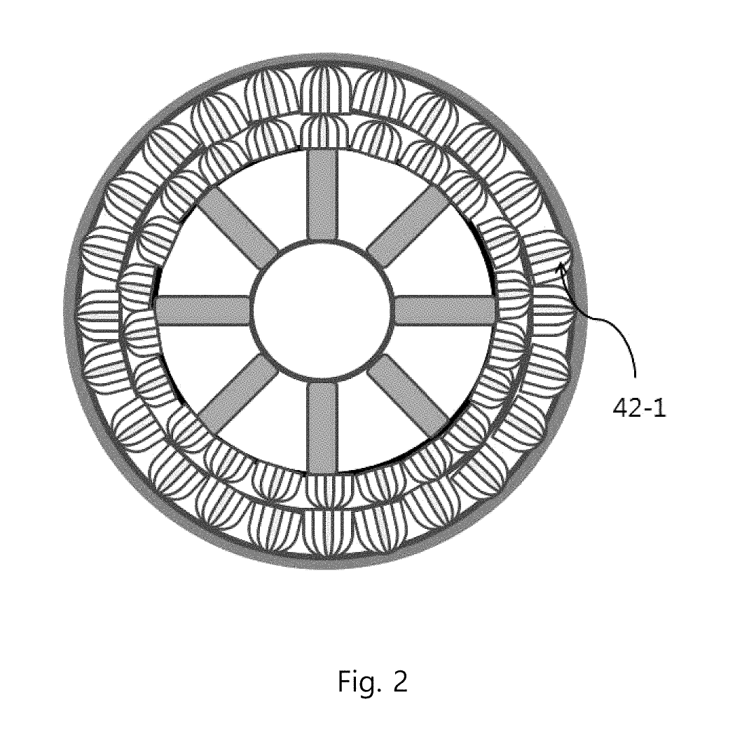

FIG. 1 shows a cross sectional view of a non-pneumatic tire including a connection of an annular series of a plurality of ellipse shape tubes in an intermediate cylindrical space in accordance with one embodiment of the present disclosure. FIG. 2 shows a cross sectional view of a non-pneumatic tire including a connection of an annular series of a plurality of arch shape tubes in an intermediate cylindrical space in accordance with one embodiment of the present disclosure.

In one aspect of the present disclosure, a non-pneumatic tire 100 may include an outer cylindrical member 10 having a tire tread portion 30 formed thereon, an inner cylindrical member 20 coupled to a wheel shaft, and a plurality of spokes disposed between and coupled to the outer cylindrical member 10 and the inner cylindrical member 20, wherein each of the inner and outer cylindrical members has a constant width along a vehicle shaft, and only the spokes disposed between the inner and outer cylindrical members radially and arranged in a given distance withstand a grounding load of the tire, wherein the spokes disposed between the inner and outer cylindrical members 10 and 20 are embodied as a connection of an annular series of a plurality of ellipse shape tubes 42 or a connection of an annular series of a plurality of arch shape tubes 42-1 in an intermediate cylindrical space 40 defined between the inner and outer cylindrical members 10 and 20, wherein the ellipse shape or arch shape of the tubes is a shape of a cross section thereof perpendicular to a rotation axis of the tire.

The number of the plurality of ellipse shape tubes 42 or the plurality of arch shape tubes 42-1 in an intermediate cylindrical space 40 may vary depending on applications of the present tire. A size of each of the ellipse shape tube 42 may vary depending on applications of the present tire. A size of each of the arch shape tube 42-1 may vary depending on applications of the present tire.

Each of the ellipse shape tube 42 may include at least one ellipse shape sub-tube 42. In this connection, the number of the at least one ellipse shape sub-tube 42 in each of the ellipse shape tube 42 may in a range of 1 to 10.

Each of the arch shape tube 42-1 may include at least one arch shape sub-tube 42-1. In this connection, the number of the at least one arch shape sub-tube 42-1 in each of the arch shape tube 42-1 may be in a range between 1 and 10.

A size of the arch shape sub-tube 42-1 may vary depending on applications of the present tire. For example, a size of the arch shape sub-tube 42-1 may be in a range between 1 and 100 mm. A size of the ellipse shape sub-tube 42 may vary depending on applications of the present tire. For example, a size of the ellipse shape sub-tube 42 may be in a range between 1 and 100 mm.

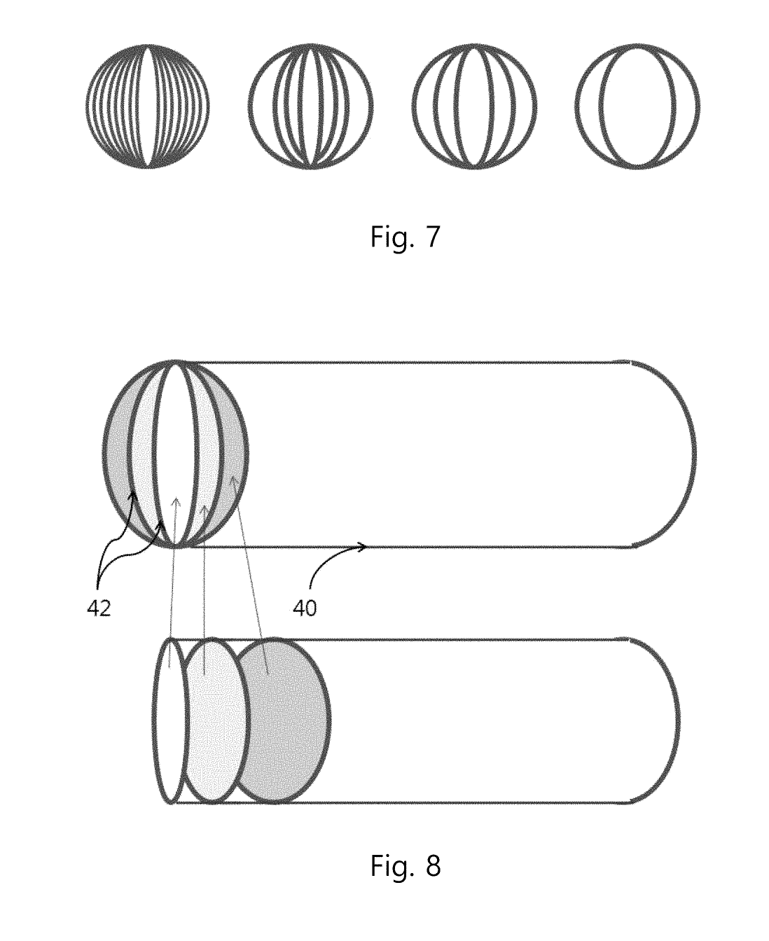

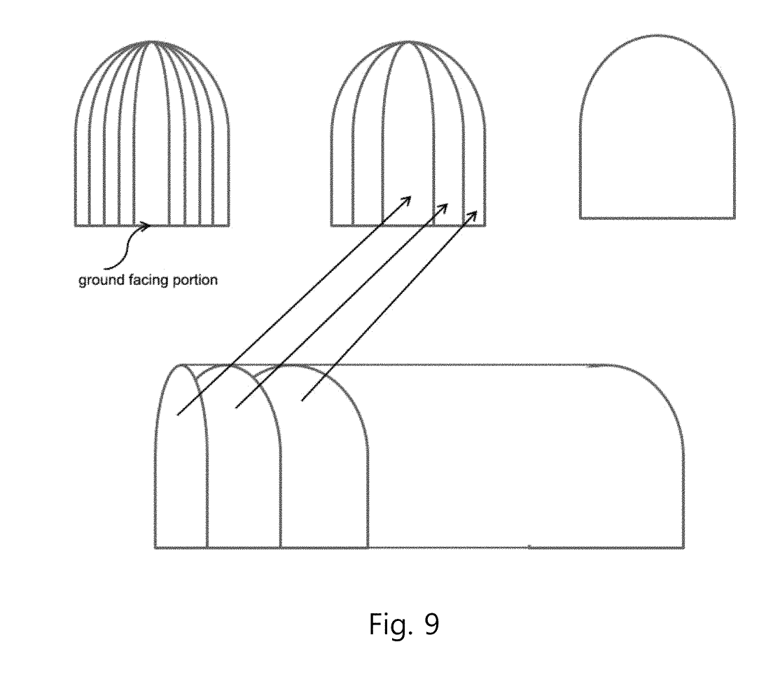

In this connection, FIG. 7 shows a cross sectional view of various configurations of an ellipse shape tube in accordance with one embodiment of the present disclosure. FIG. 8 shows a cross sectional view of one example of an ellipse shape tube in accordance with one embodiment of the present disclosure. FIG. 9 shows a cross sectional view of various configurations of an arch shape tube in accordance with one embodiment of the present disclosure.

Referring to FIG. 7 to FIG. 9, each of the ellipse shape tube 42 may include at least one ellipse shape sub-tube 42, and/or each of the arch shape tube 42-1 may include at least one arch shape sub-tube 42-1.

As shown in FIG. 7, each of the ellipse shape tube 42 may include at least one ellipse shape sub-tube 42. In this connection, an outer ellipse shape sub-tube 42 encompasses an inner ellipse shape sub-tube 42. Further, an outer ellipse shape sub-tube 42 encompasses an intermediate ellipse shape sub-tube 42 which encompasses an inner ellipse shape sub-tube 42. Further, a most-outer ellipse shape sub-tube 42 encompasses a next most-outer ellipse shape sub-tube 42. Further, a most-inner ellipse shape sub-tube 42 may be encompassed with a next most-inner ellipse shape sub-tube 42.

Similarly, as shown in FIG. 9, each of the arch shape tube 42-1 may include at least one arch shape sub-tube 42-1. In this connection, an outer arch shape sub-tube 42-1 encompasses an inner arch shape sub-tube 42. Further, an outer arch shape sub-tube 42-1 encompasses an intermediate arch shape sub-tube 42-1 which encompasses an inner arch shape sub-tube 42. Further, a most-outer arch shape sub-tube 42-1 encompasses a next most-outer arch shape sub-tube 42. Further, a most-inner arch shape sub-tube 42-1 may be encompassed with a next most-inner arch shape sub-tube 42-1.

In an example where the arch shape tube 42-1 is employed, a vertex portion of the arch shape tube 42-1 may face a ground as shown in FIG. 9.

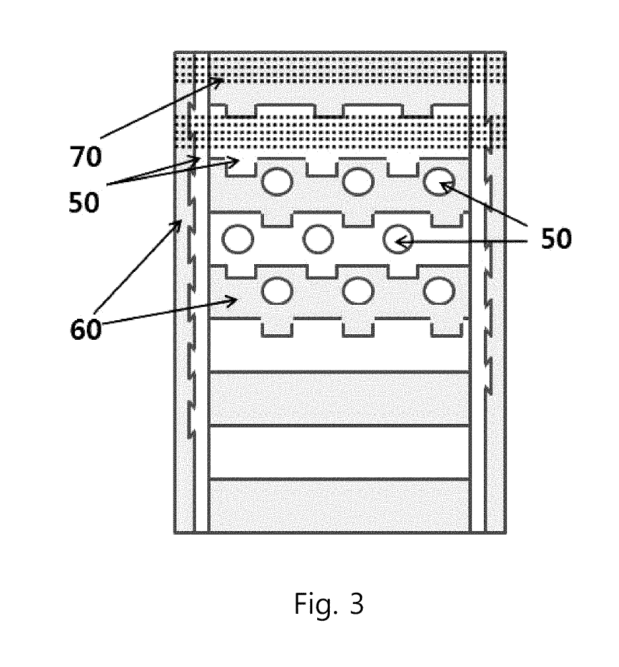

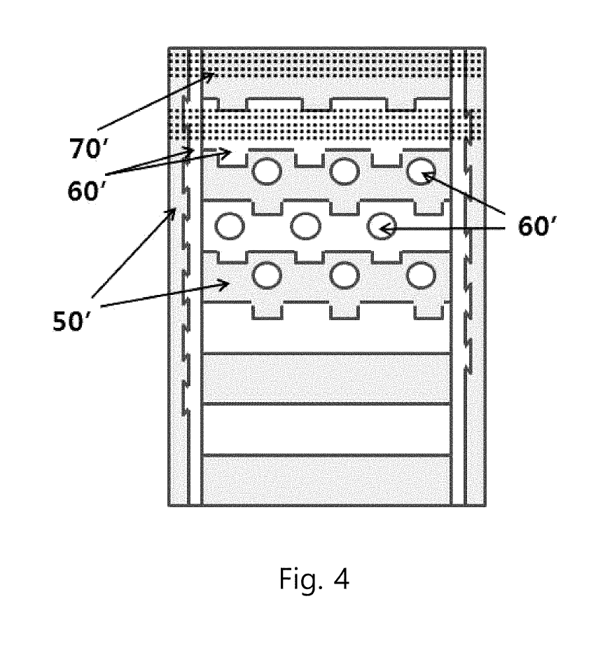

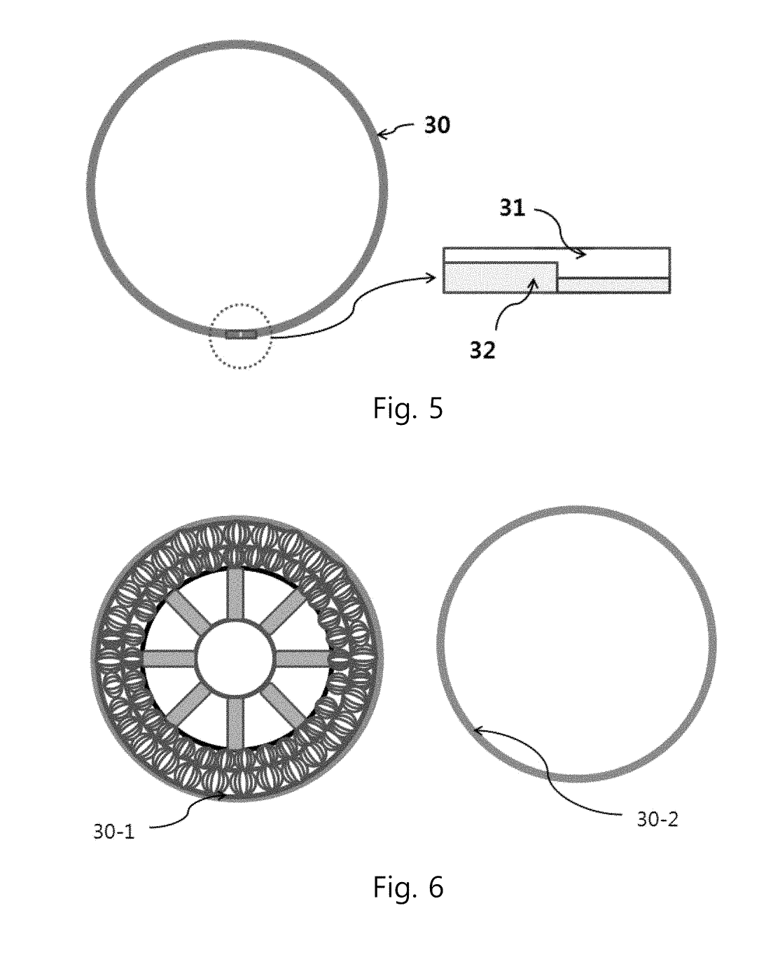

FIG. 3 shows a configuration of an outer face of a tread portion of a non-pneumatic tire in accordance with one embodiment of the present disclosure. FIG. 4 shows a configuration of an inner face of a tread portion of a non-pneumatic tire in accordance with one embodiment of the present disclosure. FIG. 5 shows a cross-section of a tread portion of a non-pneumatic tire in accordance with one embodiment of the present disclosure.

In one embodiment, the tire tread portion 30 may have a first end having a coupling groove formed therein and the second end having a coupling protrusion formed thereon, wherein the coupling protrusion is engaged with the coupling groove. In an alternative, as shown in FIG. 6, the tire tread portion 30 may be monolithic or seamless.

Alternatively, as shown in FIG. 5, the tire tread portion 30 may be cut as one point thereof such that the tire tread portion 30 may be stretched out in a linear form, and, then, the tire tread portion 30 may have two free ends having mutual engaging steps 31 and 32 formed thereon respectively. Then, the tire tread 30 may warp the body (not shown) of the tire and then the mutual engaging steps 31 and 32 may be coupled to each other using an adhesive. In this way, the tire tread 30 may be replaced when worn out.

The non-pneumatic tire tread 30 may have, at one end, an outer face portion 30-1 having micro-protrusions 70, grooves 60 and protrusions 50 formed therein or thereon. The non-pneumatic tire tread 30 may have, at the other end, a tire tread inner face portion 30-2 having corresponding micro-protrusions 70′, grooves 60′ and protrusions 50′. Thus, when the outer face 30-1 and tire tread inner face 30-2 are coupled to each other, the grooves 60 and protrusions 50 are engaged with the corresponding protrusions 50′ and grooves 60′. Thus, the non-pneumatic tire tread 30 may have a circular monolithic form as shown in FIG. 6.

As shown in FIG. 3 and FIG. 4, the non-pneumatic tire tread 30 may have an outer face portion having micro-protrusions 70, grooves 60 and protrusions 50 formed therein or thereon. The outer cylindrical member 10 may have, an inner face portion having corresponding micro-protrusions 70′, grooves 60′ and protrusions 50′. Thus, the grooves 60 and protrusions 50 may be engaged with the corresponding protrusions 50′ and grooves 60′.

In this connection, the protrusions 50, 50′ and grooves 60, 60′ may have various patterns and/or forms and/or shapes and/or sizes. For example, the protrusions 50, 50′ and grooves 60, 60′ may have a cross sectional shape of a semi-circular or polygonal shape. The protrusions 50, 50′ and grooves 60, 60′ may be arranged in a longitudinal and/or transversal direction of the tire. For example, the protrusions 50, 50′ and grooves 60, 60′ may have a cross sectional shape of an arch or triangular shape. However, the present disclosure is not limited thereto.

Using the configuration that the grooves 60 and protrusions 50 are engaged with the corresponding protrusions 50′ and grooves 60′, when the tread portion contacts the ground, a grounding load may be uniform.

The non-pneumatic tire tread portion may use at least one selected from the group consisting of natural rubbers and synthetic rubbers, or may contain therein the ceramic particles with nano- or micro-particles sizes. The body of the non-pneumatic tire may be made of at least one selected from the group consisting of polyurethane, diene based natural and synthetic rubbers, polyester fibers, Kevlar fibers, waste silk fibers, polyurethane thermoplastic resin, and carbon fibers.

The above description is not to be taken in a limiting sense, but is made merely for the purpose of describing the general principles of exemplary embodiments, and many additional embodiments of this disclosure are possible. It is understood that no limitation of the scope of the disclosure is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

What is claimed is:

1. A non-pneumatic tire comprising:
a body and a tire tread portion on the body,
wherein the body comprises an outer cylindrical member, an inner cylindrical member coupled to a wheel shaft, and a plurality of spokes disposed between and coupled to the outer cylindrical member and the inner cylindrical member,
wherein the spokes are embodied as a connection of an annular series of a plurality of ellipse shape tubes or a connection of an annular series of a plurality of arch shape tubes in an intermediate cylindrical space defined between the inner and outer cylindrical members, wherein the ellipse shape or arch shape of the tubes is a shape of a cross section thereof perpendicular to a rotation axis of the tire.

2. The tire of claim 1, wherein each of the ellipse or arch shape tubes includes at least one ellipse or arch shape sub-tube.

3. The tire of claim 2, wherein, the number of the at least one ellipse or arch shape sub-tube in each of the ellipse or arch shape tube is in a range of 1 to 10.

4. The tire of claim 2, wherein an outer ellipse or arch shape sub-tube encompasses an inner ellipse or arch shape sub-tube.

5. The tire of claim 2, wherein an outer ellipse or arch shape sub-tube encompasses an intermediate ellipse or arch shape sub-tube which encompasses an inner ellipse or arch shape sub-tube.

6. The tire of claim 2, wherein a most-outer ellipse or arch shape sub-tube encompasses a next most-outer ellipse or arch shape sub-tube, and/or a most-inner ellipse or arch shape sub-tube is encompassed with a next most-inner ellipse or arch shape sub-tube.

7. The tire of claim 1, wherein a vertex portion of the arch shape tube faces a ground.

8. The tire of claim 1, wherein the tire tread portion has a first end having a coupling groove formed therein and a second end having a coupling protrusion formed thereon, wherein the coupling protrusion is engaged with the coupling groove.

9. The tire of claim 1, wherein the tire tread portion has two free ends having mutual engaging steps formed thereon respectively, and the mutual engaging steps are coupled to each other using an adhesive.

10. The tire of claim 1, wherein the tire tread portion has, at one end, an outer face portion having micro-protrusions, grooves and protrusions formed therein or thereon, and, at the other end, an inner face portion having corresponding micro-protrusions, grooves and protrusions, wherein the grooves and protrusions of the outer face are engaged with the corresponding protrusions and grooves of the inner face.

11. The tire of claim 1, wherein the tire tread portion has an outer face portion having micro-protrusions, grooves and protrusions formed therein or thereon, and the outer cylindrical member has an inner face portion having corresponding micro-protrusions, grooves and protrusions which are engaged with the grooves and protrusions of the tread portion.

12. The tire of claim 1, wherein the body is made of at least one selected from the group consisting of polyurethane, diene based natural and synthetic rubbers, polyester fibers, Kevlar fibers, waste silk fibers, polyurethane thermoplastic resin, and carbon fibers.
